(19) United States
(12) Patent Application Publication
(10) Pub. No.: US 2009/0021054 A1
(43) Pub. Date: Jan. 22, 2009

(54) DRAINAGE ARRANGEMENT

(75) Inventors: Ruediger Knape, Salzgitter (DE); Gero Wedderkopf, Hildesheim (DE)

Correspondence Address: FOX ROTHSCHILD LLP, 1101 MARKET STREET, SUITE 2600, PHILADELPHIA, PA, 19107-2950, US

(73) Assignee: Meteor Gummiwerke K.H. Badje GmbH & Co. KG, Bockenem (DE)

(21) Appl. No.: 12/278,460

(22) PCT Filed: Dec. 1, 2006
(86) PCT No.: PCT/EP06/11538

§ 371 Date: Aug. 6, 2008

(30) Foreign Application Priority Data
Feb. 22, 2006 (DE) 20 2006 002 765.3

(51) Int. Cl. B60J 7/04

(52) U.S. Cl. 296/213

(57) ABSTRACT

A drainage arrangement for a vehicle roof comprising two roof parts (1, 2) which are arranged on a vehicle body in a manner such that they can be pivoted between a closed position and an open position is formed by an elastic drainage line which interacts with the pivotably mounted, fixed roof parts (1, 2) and, with regard to fault-free operation, is divided into two sections which are connected to each other via a separating device (8), wherein the individual sections move virtually as rigid bodies during the pivoting movement of the roof parts (1, 2). As a consequence of a pivoting movement of the linkage supporting the roof parts (1, 2), the separating device (8) can be switched between an open position, in which rainwater can be discharged in an orderly manner via the drainage line, and a closed position, in which rainwater is held back in a collecting region containing a collecting container (6). As a result of the fact that the drainage line is divided into at least two sections which as such are not subject to any deformation during a pivoting movement of the roof parts (1, 2), a reliable construction of the drainage arrangement preventing deformation of the drainage line is provided.

The invention relates to a drainage arrangement for a vehicle roof according to the preamble of claim 1.

DE 101 37 031 discloses a drainage arrangement for a folding roof of a hardtop vehicle, in which, in an open position of the roof, a rear window can be pivoted into a retraction position within the trunk, wherein a roof pillar which is adjacent in the side region to the rear window, the C pillar, can likewise be pivoted. A water guiding channel extends along the lower edge of the rear window and is continued in the region of the C pillar and is connected in a lower region to a collecting trough. The latter is fastened to the abovementioned C pillar and is therefore subject to the pivoting movements thereof during each opening and closing operation of the roof. A flexible drainage hose which permits orderly drainage leads away from the collecting trough. A problem with said drainage arrangement is that, during each folding movement of the roof, the drainage hose, the one end of which is connected to the collecting trough and the other end of which is connected to a connecting point fixed on the chassis, is subject to considerable movements which cause deformation.

A particular problem of draining vehicle roofs which comprise fixed roof parts which can be pivoted by means of a linkage system and can be pivoted between a closed position and a retraction position is to reliably feed residual water possibly located on the outer sides of the roof surfaces for orderly disposal before an opening movement is introduced and in particular not to allow said residual water to enter the passenger compartment. Since the folding operation of the roof parts and the flowing away of the abovementioned residual water proceed virtually at the same time, the emptying points for said water have to be positioned taking the path of movement of the roof parts into consideration, with the proviso that drainage of water is possible in every phase of the movement.

EP 1 275 545 discloses a vehicle roof with two fixed, pivotably arranged roof parts, along the abutting edges of which—as seen in the transverse direction of the vehicle—sealing profiles extend, said sealing profiles at the same time forming collecting grooves for surface water of the roof parts, which surface water flows away from the latter during the folding operation thereof in the direction of a retraction position. By contrast, in the closed state of the roof, the collecting grooves do not have a function. The collecting grooves each form two globally U-shaped cross-section profiles which are nested one inside the other, are arranged facing each other and by means of which it is ensured that, in each phase of the movement of the roof parts in the direction of an open state, water flowing off from their surfaces is reliably collected. Starting from the collecting grooves, the water first of all passes via molded parts located at the lateral ends of the sealing profiles into drainage hoses which are fastened to the linkage system supporting the roof parts. This means that every folding operation of the roof is in turn associated with a considerable mechanical load, in particular deformation of the drainage hoses. Depending on the specific manner in which said hoses are laid, in particular in conjunction with the relative movements of those parts of the linkage system which support the hoses, buckling of a hose, which at least obstructs the water from flowing off, cannot be sufficiently reliably prevented in individual cases during a folding operation of the roof. Further risks arising from the specific design of the linkage system, in particular of the kinematics and/or of the arrangement of the components thereof and of the connection of the hoses thereto can be caused by excessive deformation which may result in destruction due to a tearing-off action or even a shearing-off action.

Against this background, it is the object of the invention to design a drainage arrangement of the type described at the beginning which, while avoiding the disadvantages associated with the prior art, in particular while reducing the mechanical stress on drainage hoses, permits a fault-free drainage of a vehicle roof comprising at least one, generally more than one, pivotably coupled, fixed roof parts. This object is achieved in the case of a drainage arrangement of this type by means of the features of the characterizing part of claim 1.

According thereto, it is essential to the invention that a drainage line which adjoins the collecting channels of the sealing profiles assigned to the pivotably arranged roof parts is divided into at least two sections with the use of at least one separating device. The purpose of said separating device is to reduce the mechanical stress on the drainage line during the pivoting movements of the roof parts by said drainage line being divided into sections which, as such, experience virtually no deformation during the pivoting movement such that, in a reversal of the prior art explained at the beginning, no malfunctions caused by excessive deformation, such as, for example, buckling or even destruction due to a tearing-off action, shearing-off action or the like, can occur. The abovementioned sections are selected according to structural elements of the vehicle roof which serve to bring about the folding operation and accordingly are arranged pivotably, but are rigid as such. The separating device forms an intersection between two sections in each case and can be switched between a closed position and a passage position. It should therefore be placed between two structural elements which can be pivoted relative to each other, and has to be provided to the effect that it is capable of absorbing pivoting movements of the structural elements. This gives rise to the possibility of blocking the passage through the drainage line during certain operating states, for example, of the folding roof.

According to the features of claim 2, at least one collecting region is located between the abovementioned collecting channels and the separating device, said collecting region being provided in the open position of the separating device in order to collect and hold back surface water from the roof parts. By contrast, the stored water can flow out of said collecting region as soon as the separating device has been switched again into its closed or passage position, an operating state which arises with the closed position of the roof parts.

According to the features of claim 3, the collecting region can advantageously be formed by means of a collecting container. The latter is arranged at a suitable location—as seen in the direction of flow of the surface water flowing off—in front of the separating device.

According to the features of claim 4, a molded part is located between the collecting channels and the drainage line, said molded part forming the binding element between, if appropriate, a plurality of collecting channels and a drainage line. The collecting container mentioned at the beginning may at the same time advantageously, if appropriate, also be integrated in said molded part. However, a molded part which is independent of the function of the connecting point can also be provided for the collecting container as part of the collecting region.

The drainage line is formed in a manner known per se by means of hoses which, according to the features of claim 5, are fastened to those parts of a linkage which are intended for the pivoting of the roof parts. The dimensioning of said sections therefore takes place as a function of the dimensioning of those sections of the linkage which are in each case rigid as such. The switching movements required for actuation of the separating device can advantageously be derived from the pivoting movement of parts of the linkage system supporting the roof parts.

According to the features of claim 6, the separating device is located in the vicinity of a pivot axis provided for the pivoting of roof parts, therefore in the vicinity of an intersection between two lever elements of a linkage, here of the roof linkage. This is advantageous with regard to the specific configuration of the separating device which, in its closed position, has to permit corresponding movements of the end points of those sections of the drainage line which are bridged by said separating device. It is essential in this connection that the separating device is arranged with the proviso that its switching operation between an open and a closed position, in particular the switching movements required for this purpose, is at least partially brought about by those parts of the roof linkage or by structural elements fastened directly to the latter, which parts or structural elements, during the movement of the roof parts, execute relative movement from which the abovementioned switching movements can be derived.

The features of claim 7 are focused directly on the separating device which, according thereto, comprises two structural elements which are fastened to different linkages of the roof linkage which brings about the pivoting of the roof parts. According thereto, a further structural framework condition of the structural elements is that the pivoting movement of the two linkages relative to each other is converted into a switching movement via which the separating device can be switched between its closed position and its passage position.

The features of claims 8 and 9 are focused on a specific configuration of the separating device. According thereto, one of its structural elements contains a valve, the valve disk of which is movable between an open and a closed position by the other of the two structural elements via a tappet integrally formed on said valve disk. The other of the abovementioned structural elements is formed by a collecting plate, which, as a consequence of a pivoting movement of the two linkages, comes to bear against the tappet and thereby moves the valve disk between its open and its closed position.

According to the features of claims 10 and 11, both of the abovementioned structural elements are provided with connecting branches which are intended for the connection of hoses which form sections of the drainage line.

According to the features of claim 12, the valve disk of the valve located in the one structural element is acted upon by a spring via which said valve experiences elastic prestressing in the direction of one of its switching positions, for example its closed position.

The basic concept of the invention, with regard to fault-free operation, of dividing an elastic drainage line, which is preferably provided in the form of a hose and interacts with a plurality of, for example two, pivotably mounted, fixed roof parts, into two sections which are connected to each other via a separating device such that, during a pivoting movement of the roof parts, the individual sections move virtually as rigid bodies, is not restricted to the use just of one separating device and therefore the formation of two sections of a drainage line. According to the kinematic framework conditions, in particular the number of pivotable linkage parts, it may also comprises more than one separating device and therefore more than two sections which, in turn, can be switched between a closed position and an open position as a function of the pivoting movement of the roof parts, to be precise, preferably with temporary storage of surface water which arises in receiving containers. A configuration and arrangement of the drainage line in a manner which is therefore suitable in terms of stress increases the service life of a drainage arrangement of this type.

The invention is explained in more detail below with reference to the exemplary embodiment which is reproduced schematically in the drawings, in which:

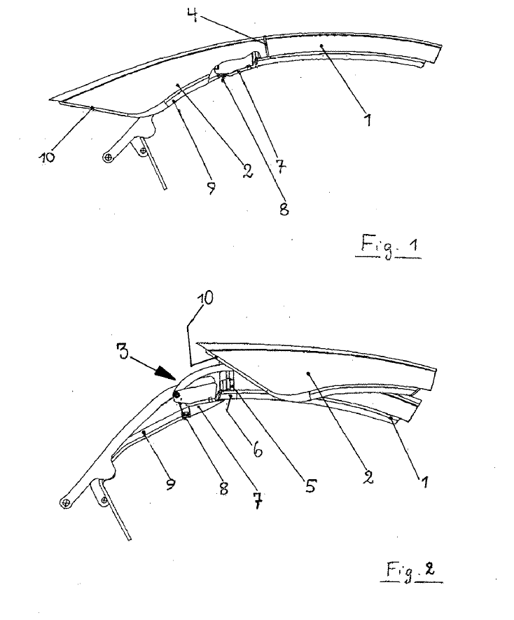

FIG. 1 shows an illustration of the closed position of a motor vehicle folding roof, which comprises a front and a rear roof part, in a side view;

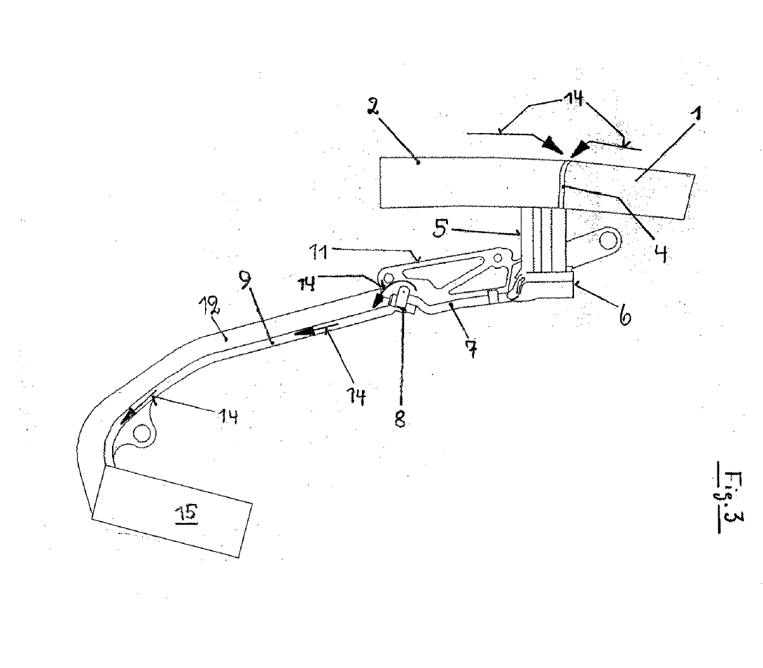

FIG. 2 shows an illustration of the folding roof according to FIG. 1 in a transition position toward the open position;

FIG. 3 shows an enlarged partial illustration of water-conducting elements of a drainage arrangement in the connecting region between two roof parts of a folding roof;

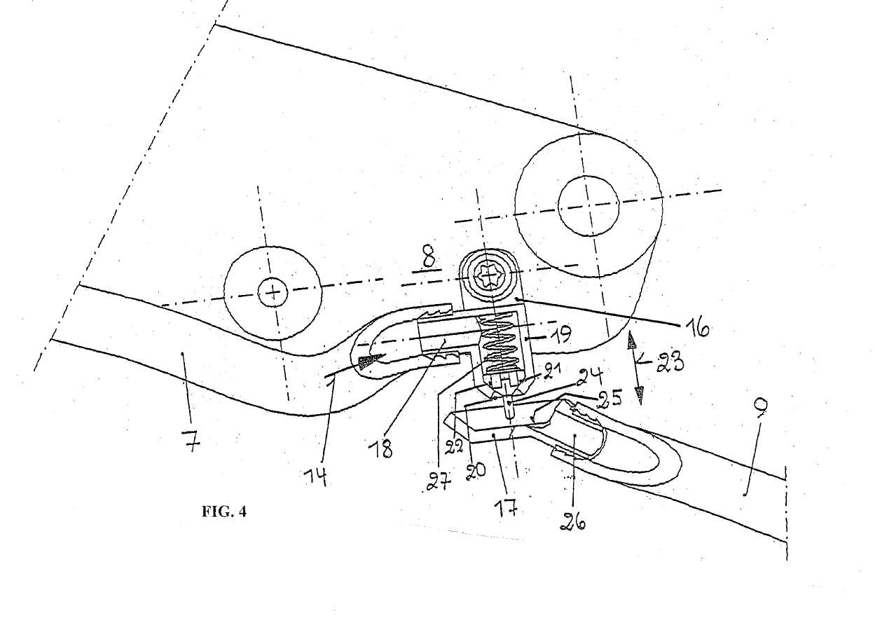

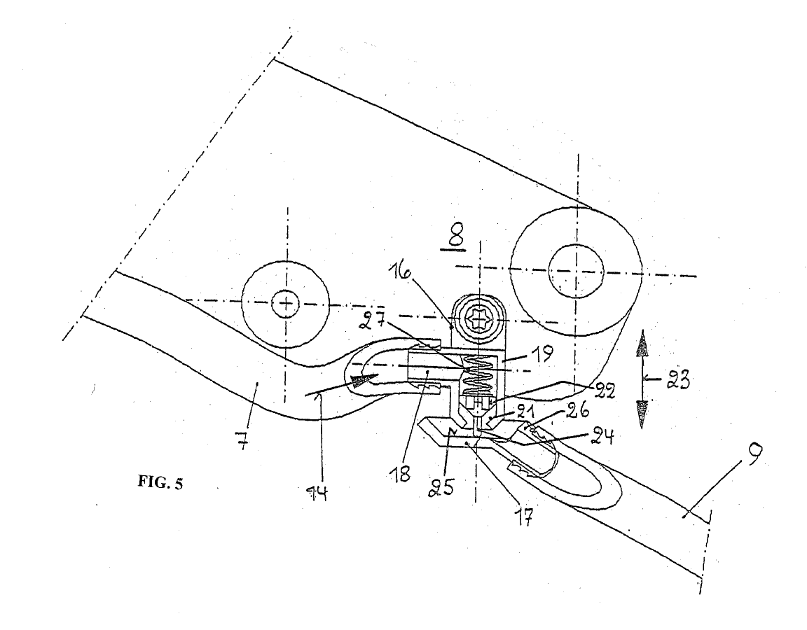

FIG. 4 shows a further enlarged partial illustration of a separating device, which is in the closed position, between two sections of water-conducting parts of the drainage arrangement according to FIG. 3;

FIG. 5 shows an illustration of the separating device according to FIG. 4 in the open position.

In FIGS. 1 and 2, that roof part which is in front, as seen in the direction of travel of a vehicle, of a folding roof comprising two fixed roof parts is referred to by 1, said roof part together with a rear roof part 2 completing the roof surface in the closed position shown in FIG. 1. The two roof parts 1, 2 are pivotably coupled to a chassis (not illustrated in the drawing) in manner known per se by means of a roof linkage 3. For the transfer into the complete open position from the closed position shown in FIG. 1, first of all the rear roof part 2—as shown in FIG. 2—is pivoted toward the front roof part 1, with the two roof parts 1, 2 subsequently being pivoted in a space-saving manner as a “package” into the trunk of the vehicle.

A more detailed description of the kinematics of the folding operation of the two roof parts 2, 2 is omitted below.

A sealing profile 4 which extends transversely with respect to the longitudinal extent of the vehicle and opens at at least one of its two lateral ends into a molded part 5 is located at the location of the joint between the two roof parts 1, 2. The sealing profile 4 forms a seal in the region of the joint between the two roof parts 1, 2 and is designed at the same time in order to conduct away rainwater which arrives on it in the direction of the at least one molded part 5. The molded part 5 therefore serves to collect said surface water and to conduct it away in an orderly manner.

A collecting container 6, to the output side of which at least one flexible hose 7 is connected, is connected to the molded part 5, said hose leading via a separating device 8 (which is yet to be described in more detail below) to a further flexible hose 9 which, for its part, is provided and arranged for conducting away water in an orderly manner.

A sealing profile which is arranged at the rear border of the rear roof part 2 and, like the sealing profile 4, is provided (in a manner not illustrated in the drawing) to collect penetrating surface water and which, if appropriate, can be continuously connected to a molded part 5 via hoses arranged in between is referred to by 10.

FIG. 1 shows the two roof parts 1, 2 in their closed position. The latter is characterized in that rainwater which arrives on the roof parts is collected via the sealing profiles 4 in collecting channels (not reproduced in the drawing) and can be conducted away via hoses 7, 9. A collecting container 6 and a separating device 8 are located over the course of said hoses, said separating device, in the closed position of the two roof parts, being in an open position which permits unhindered passage of water.

For the transfer into the closed position from the open position shown in FIG. 1, first of all the rear roof part 2 is pivoted—as shown in FIG. 2—onto the front roof part 1, with the two roof parts subsequently being pivoted as a package into a receiving compartment in the trunk. According to the invention, a transfer of the separating device 8 into a closed position is associated with said opening movement such that, as a result, surface water which was still located on the roof parts 1, 2 before the beginning of the folding operation is received via the collecting channels of the sealing profiles 4 and collected in at least one collecting container 6 as a consequence of the closed position of the separating device.

The dimensioning of the collecting container 6/of the collecting containers 6 and the arrangement thereof is always provided, with the proviso that, as a consequence of the opening movement, surface water flowing off from the roof parts cannot enter the vehicle interior but rather is supplied for temporary storage in the collecting container/collecting containers 6. However, temporary storage is not restricted to the collecting container and can additionally also be provided in all of the line sections upstream of the separating device, including in the region of the sealing profile 4. In general, a collecting region in which water can be stored is therefore provided.

If a transfer back of the roof parts 1, 2 into the closed position shown in FIG. 1 subsequently takes place, the water collected in the collecting containers or in the collecting regions can flow off in an orderly manner as a result of the separating device 8 being now opened again.

FIG. 3 shows, in an enlarged illustration, the spatial arrangement of the separating device 8 within those parts of the drainage arrangement which are intended for conducting water. Said separating device forms the binding element between the hose 7, which is attached to a front linkage 11, and the hose 9, which is attached to a rear linkage 12. The front and rear linkages 11, 12 are arranged pivotably with respect to each other about a pivot point (not illustrated in the drawing) which is located at the location 13, with pivoting taking place in the event of the roof being transferred from the closed position into the open position and vice versa. This pivoting movement is used at the same time in a manner which is yet to be explained in more detail below in order to switch the separating device 8 between its respective open and closed positions.

FIG. 3 shows the roof in its closed position, with the arrows 14 indicating the outflow direction of rainwater striking against the roof surface. In FIG. 3 and the following figures of the drawing, functional elements which correspond to those of FIGS. 1 and 2 are correspondingly numbered such that a repeated description in this regard can be omitted.

An outflow system into which the hose 9 opens at the lower end of the rear linkage 12 is referred to globally by 15.

FIG. 4 shows the separating device 8 in an enlarged illustration between the hoses 7, 9. The separating device 8 is formed by a valve, the housing 16 of which is fastened to the front linkage 11 and which interacts with a collecting plate 17 which is fastened to the rear linkage 12.

The housing 16 is provided with a connecting branch 18 for the hose 7, said connecting branch leading via a cylinder 19 to an outlet opening 20, the inner walls of the cylinder 19 which face the outlet opening 20 being designed as a valve seat for a valve disk 22 which is accommodated in a slideable manner in the direction of the arrows 23 within the cylinder 19.

A tappet 24, the lower end of which is located at a distance above the base 25 of the collecting plate 17 in the closed position (shown in FIG. 4) of the valve is integrally formed on the valve disk 22—in a manner extending coaxially with respect to a longitudinal axis of the cylinder 19 and projecting out of the outlet opening 20.

A connecting branch 26 to which the hose 9 is connected opens into the base region of the collecting plate 17.

The valve disk 22 is held in the closed position by a spring 27 which is located within the cylinder 19 and likewise extends coaxially within the cylinder 19.

If, starting from the closed position (shown in FIG. 4) of the separating device 8 which is assigned to the open position of the roof parts 1, 2, the closing movement of the roof parts 1, 2 is now initiated, this is associated with a pivoting movement of the front and rear linkages 11, 12 relative to each other, to be precise to the effect that the collecting plate 17 moves essentially in the direction of the arrows 23 toward the housing 16 such that it finally comes into contact between the tappet 24 and the base 25. A further movement of the collecting plate 17 in the direction of the housing 16 finally transfers the valve or the valve disk 22 into the open position such that a continuous connection is now provided between the hoses 7, 9. The closed position of the roof parts 1, 2 corresponds to the open position of the separating device 8 such that rainwater striking against the roof parts can now flow unobstructed via the hoses 7, 9 in the direction of the outflow system 15. As a consequence of the position of the linkages 11, 12 relative to each other, the separating device is, as a result, held in its open position.

By contrast, as a consequence of a pivoting of the linkages 11, 12, transfer again of the roof parts 1, 2 into their open position causes the collecting plate 17 to move away from the housing 16 and accordingly causes a closing movement of the valve disk 22, which movement is initiated under the action of the spring 27, in the direction of the outlet opening 20. Surface water which passes in this phase via the sealing profiles 4 into the abovementioned collecting region, in particular the collecting container 6, is therefore stored therein during the opening phase of the roof. Such storage likewise takes place in the sealing profile 4 itself and in further line elements between the latter and the separating device.

It can be seen with reference to the above statements that a folding roof equipped with a drainage arrangement according to the invention permits a convenient, fault-free operation which, in particular, is free from water penetrating during the folding movements of the roof parts. It can furthermore be seen that the existing drainage line is divided starting from the molded part 5 as far as the outflow system 15 into sections, the length and profile of which are provided according to the linkages 11, 12, with the abovementioned separating device 8 forming the binding element between said sections and being arranged in the vicinity of a common pivot axis which connects the linkages 11, 12 and is located at the location 13. During a folding operation of the roof parts 1, 2, the hoses 7, 9 which are fastened to the linkages 11, 12 are therefore not subject to any deformation but rather move virtually as rigid bodies together with the linkages 11, 12.

1-12. (canceled)

13. A drainage arrangement for a vehicle roof comprising at least two fixed roof parts (1, 2) which are arranged on a vehicle body in a manner such that they can be pivoted between a closed and an open position or retraction position, wherein each roof part (1, 2) is at least partially surrounded by a sealing profile (4) which is connected via a collecting channel to a drainage line, characterized in that the drainage line is divided into at least two sections by means of at least one separating device (8) which can be switched between a closed position and a passage position, and in that the abovementioned sections are selected according to structural elements of the vehicle roof which are intrinsically rigid during a pivoting operation of the roof parts between an open and a closed position and are movable relative to one another.

14. The drainage arrangement as claimed in claim 13, characterized in that at least one collecting region is arranged over the course of the connection between the abovementioned collecting channel and the separating device (8), and in that the collecting region and the separating device (8) are arranged with the proviso that the drainage line is interrupted during the introduction of the opening movement of the vehicle roof and during the existence of an open state, and residual surface water arising at the roof parts (1, 2) is collected and held back in the collecting region.

15. The drainage arrangement as claimed in claim 14, characterized in that the collecting region comprises a collecting container (6).

16. The drainage arrangement as claimed in claim 15, characterized in that the connection between the collecting channel and the drainage line is formed by a molded part (5) into which the collecting container (6) is bound.

17. The drainage arrangement as claimed in claim 13, characterized in that the first section of the two sections of the drainage line, which section is located between the collecting container (6) and the separating device (8), is formed by a hose (7), and the second section of the two sections of the drainage line, which section adjoins the separating device (8), is formed by a hose (9), the hoses (7, 9) being fastened to parts of the linkage (11, 12) which is intended for the pivoting of the roof parts (1, 2) and supports the latter.

18. The drainage arrangement as claimed in claim 13, characterized in that the separating device (8) is arranged in the vicinity of a pivot axis provided for the pivoting of roof parts (1, 2), and therefore those sections of the drainage line which adjoin both sides of the separating device (8) do not undergo any deformation whatsoever because of the opening and closing operation of the vehicle roof.

19. The drainage arrangement as claimed in claim 17, characterized in that the separating device (8) comprises two structural elements, one of which is fastened to the first linkage (11) and the other of which is fastened to the second linkage (12), and in that the structural elements are designed and arranged with the proviso that a pivoting movement of the two linkages (11, 12) relative to each other can be converted into a switching movement via which the separating device (8) can be switched between the closed position and the passage position.

20. The drainage arrangement as claimed in claim 19, characterized in that one of the abovementioned structural elements comprises a housing (16) which contains a valve and in which a valve disk (22) is arranged in a manner such that it is movable between an open and a closed position.

21. The drainage arrangement as claimed in claim 19, characterized in that the other of the abovementioned structural elements comprises a collecting plate (17) which is arranged at a distance from the housing (16), in that a tappet (24) is attached to the valve disk (22) and is intended for interacting with the collecting plate (17) to the effect that, as a consequence of the relative movement of the collecting plate (17) in a direction toward the tappet (24) or away from the latter, the valve disk (22) is movable between its open and its closed position.

22. The drainage arrangement as claimed in claim 19, characterized in that a connecting branch (18) intended for the connection of the first hose (7), which is located between the collecting container (6) and the separating device (8), is integrally formed on one of the two structural elements.

23. The drainage arrangement as claimed in claim 19, characterized in that a connecting branch (26) intended for the connection of the hose (9), which adjoins the separating device (8), is integrally formed on the other of the two structural elements.

24. The drainage arrangement as claimed in claim 20, characterized in that the movement of the valve disk (22) in the direction of its open position is applied counter to the resetting force of a spring (27).

25. The drainage arrangement as claimed in claim 14 characterized in that the first section of the two sections of the drainage line, which section is located between the collecting container (6) and the separating device (8), is formed by a hose (7), and the second section of the two sections of the drainage line, which section adjoins the separating device (8), is formed by a hose (9), the hoses (7, 9) being fastened to parts of the linkage (11, 12) which is intended for the pivoting of the roof parts (1, 2) and supports the latter.

26. The drainage arrangement as claimed in claim 15 characterized in that the first section of the two sections of the drainage line, which section is located between the collecting container (6) and the separating device (8), is formed by a hose (7), and the second section of the two sections of the drainage line, which section adjoins the separating device (8), is formed by a hose (9), the hoses (7, 9) being fastened to parts of the linkage (11, 12) which is intended for the pivoting of the roof parts (1, 2) and supports the latter.

27. The drainage arrangement as claimed in claim 16 characterized in that the first section of the two sections of the drainage line, which section is located between the collecting container (6) and the separating device (8), is formed by a hose (7), and the second section of the two sections of the drainage line, which section adjoins the separating device (8), is formed by a hose (9), the hoses (7, 9) being fastened to parts of the linkage (11, 12) which is intended for the pivoting of the roof parts (1, 2) and supports the latter.

28. The drainage arrangement as claimed in claim 14, characterized in that the separating device (8) is arranged in the vicinity of a pivot axis provided for the pivoting of roof parts (1, 2), and therefore those sections of the drainage line which adjoin both sides of the separating device (8) do not undergo any deformation whatsoever because of the opening and closing operation of the vehicle roof.

29. The drainage arrangement as claimed in claim 15, characterized in that the separating device (8) is arranged in the vicinity of a pivot axis provided for the pivoting of roof parts (1, 2), and therefore those sections of the drainage line which adjoin both sides of the separating device (8) do not undergo any deformation whatsoever because of the opening and closing operation of the vehicle roof.

30. The drainage arrangement as claimed in claim 16, characterized in that the separating device (8) is arranged in the vicinity of a pivot axis provided for the pivoting of roof parts (1, 2), and therefore those sections of the drainage line which adjoin both sides of the separating device (8) do not undergo any deformation whatsoever because of the opening and closing operation of the vehicle roof.

31. The drainage arrangement as claimed in claim 18, characterized in that the separating device (8) comprises two structural elements, one of which is fastened to the first linkage (11) and the other of which is fastened to the second linkage (12), and in that the structural elements are designed and arranged with the proviso that a pivoting movement of the two linkages (11, 12) relative to each other can be converted into a switching movement via which the separating device (8) can be switched between the closed position and the passage position.

32. The drainage arrangement as claimed in claim 31, characterized in that one of the abovementioned structural elements comprises a housing (16) which contains a valve and in which a valve disk (22) is arranged in a manner such that it is movable between an open and a closed position.
